(19) United States
(12) Patent Application Publication
(10) Pub. No.: US 2013/0179896 A1
(43) Pub. Date: Jul. 11, 2013

(54) Multi-thread processing of an XML document

(71) Applicant: Alex Kalaidjian, Ottawa (CA)

(72) Inventor: Alex Kalaidjian, Ottawa (CA)

(73) Assignee: Adobe Systems Incorporated

(21) Appl. No.: 12/321,982

(22) Filed: Jan. 27, 2009

(51) Int. Cl. G06F 9/46

(52) U.S. Cl. 718/107

(57) ABSTRACT

An indication to process an Extensible Markup Language (XML) document that includes a hierarchy of nodes is received. A set of one or more page nodes to be processed is obtained, where the set of page nodes are part of the hierarchy of nodes. A plurality of threads is created. One of the set of page nodes and those nodes, if any, in the hierarchy that descend from that node are assigned to one of the plurality of threads to be processed by that thread. Processing, by said one of the plurality of threads, of the assigned page node and those nodes that descend from that page node is initiated.

### BACKGROUND OF THE INVENTION

Devices, such as computers, with more than one processor are sometimes referred to as multi-core processors. Multi-core processors are becoming increasingly common with dual-core processors, quad-core processors, and even some 8-core processors available today. A conventional software application (i.e., written or otherwise designed for a single processor) will not automatically take advantage of the increased performance offered by multi-core processors. It would be desirable to develop new techniques associated with multi-core processing.

### BRIEF DESCRIPTION OF THE DRAWINGS

Various embodiments of the invention are disclosed in the following detailed description and the accompanying drawings.

FIG. 1A is a diagram illustrating an embodiment of an Extensible Markup Language (XML) form with a plurality of pages.

FIG. 1B is a diagram showing an embodiment of an XML form as displayed.

FIG. 2 is a flowchart illustrating an embodiment of a process for processing a form using a multi-core processor.

FIG. 3 is a flowchart illustrating an embodiment of a process for processing an XML form using a single thread or multiple threads.

FIG. 4 is a system diagram showing an embodiment of a computer with a multi-core processor.

FIG. 5 illustrates one embodiment of a general purpose computer system.

### DETAILED DESCRIPTION

The techniques disclosed herein can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the approaches may take, may be referred to as techniques. In general, the order of the steps of disclosed processes may be altered within the scope of the techniques. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the techniques is provided below along with accompanying figures that illustrate the principles of the techniques. The techniques are described in connection with such embodiments, but are not limited to any embodiment. The scope is limited only by the claims and the techniques encompass numerous alternatives, modifications and equivalents. Numerous specific details are set forth in the following description in order to provide a thorough understanding. These details are provided for the purpose of example and the techniques may be practiced according to the claims without some or all of these specific details. For the purpose of clarity, technical material that is known in the technical fields related to the techniques has not been described in detail so that the techniques are not unnecessarily obscured.

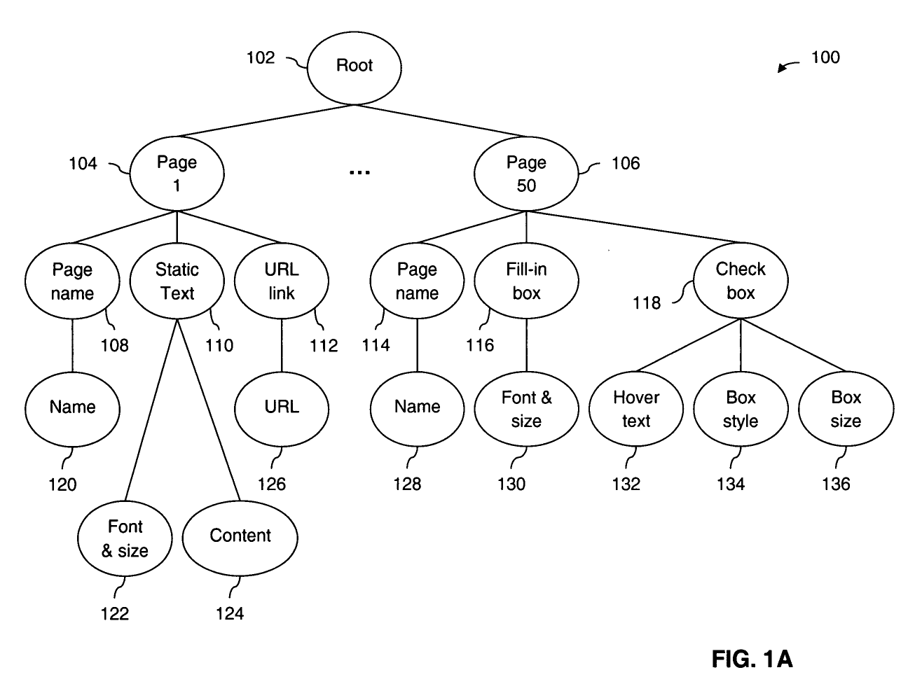

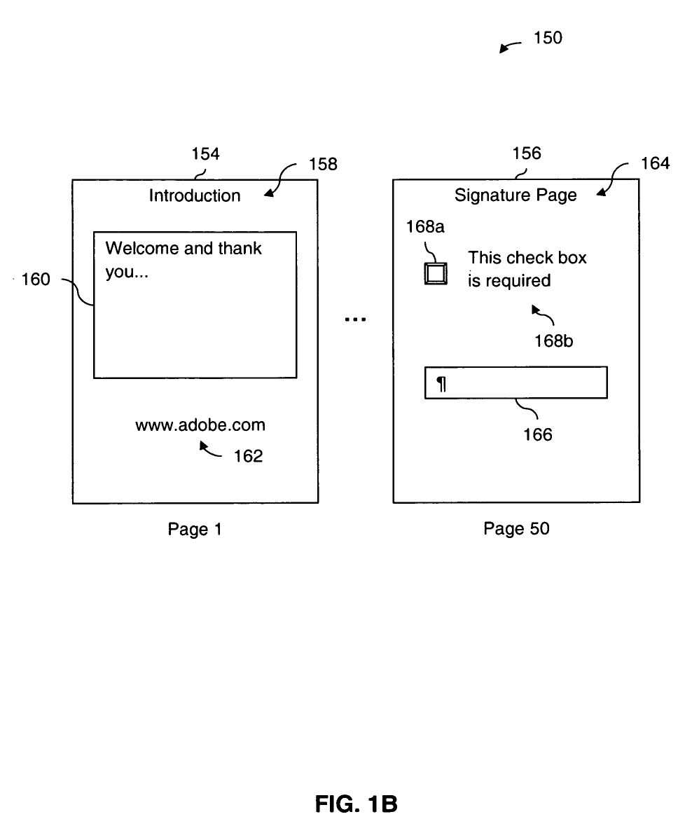

FIG. 1A is a diagram illustrating an embodiment of an Extensible Markup Language (XML) form with a plurality of pages. In the example shown, XML form 100 has 50 pages, each page of which has content which is laid out or otherwise placed within a page. An XML form (or, more generally, an XML document) includes objects and properties of those objects; these pieces of information are stored as nodes and organized hierarchically as shown in this example. Root node 102 is the highest node in this hierarchy and all other nodes descend from it. Root node 102 has a plurality of children and each page in the form corresponds to a child node of root node 102 in this example. For example, page 1 corresponds to node 104 and page 50 corresponds to node 106. For clarity, nodes corresponding to pages 2-49 are not shown.

Node 104 (corresponding to page 1) has child nodes 108, 110, and 112 which correspond (respectively) to a page name object, a static text object, and a Uniform Resource Locator (URL) link object. Each object has one or more properties which is/are represented in XML form 100 as children of the given object. For example, name node 120 contains or corresponds to the property of the page name object of node 108 and is the child of node 108. Static text node 110 has children font and size node 122 and content node 124. URL link node 112 has URL node 126 as a child.

Page name node 114, fill-in box node 116, and check box 118 are children of node 106 (corresponding to page 50). Page name node 114 has name node 128 as a child, fill-in box node 116 has font and size node 130 as a child, and check box 118 has hover text node 132, box style node 134, and box size node 136 as children. In some embodiments, page name nodes 108 and 114 correspond to two instantiations of the same object with different properties.

FIG. 1B is a diagram showing an embodiment of an XML form as displayed. In the example shown, displayed XML form 150 is the displayed or rendered version corresponding to XML form 100 from FIG. 1A. Displayed XML form 150 includes displayed pages 154 and 156, corresponding to pages 1 and 50, respectively. Displayed page 1 includes a page name 158 of “Introduction”, static text 160 of “Welcome and thank you . . . ” and URL 160 of “www.adobe.com”. These displayed or rendered elements of page 1 correspond to nodes 108, 110, 112, 120, 122, 124, and 126 which descend from node 104 in FIG. 1A. Displayed page 50 includes a page name 164 of “Signature Page”, fill-in box 166, checkbox 168a, and hover text 168b saying “This check box is required”.

In this example, displayed XML form 150 is an interactive form where a user interacts with the form during run time to (for example) provide information, select/deselect check boxes or other provided controls, or cause some underlying function or process of the form to be performed (e.g., print form, e-mail form, save form, etc.). For example, displayed XML form 150 may be a credit card application which requires an applicant to provide personal information (e.g., name, date of birth, or marital status), contact information (e.g., address and telephone number), employment history (e.g., title, current employer, length of employment there), financial information (e.g., income or credit scores) using a variety of controls or interfaces such as check boxes, radio knobs, fill-in boxes, pull-down menus, and/or action buttons may be used included in a form.

The XML form shown in FIGS. 1A and 1B are merely examples and in some other applications vary from the example shown. For example, in XML form 100, page nodes 104 and 106 are located in the second level of the hierarchy (i.e., the page nodes are children of the root node). In some other embodiments, page nodes are located at some other position or level in the hierarchy (e.g., at the third level). In various embodiments, various nodes that descend from a page node represent or correspond to an image, button, text field, container, bar code, shape (e.g., rectangles, circles, lines, etc.), etc.

To create or develop a form, a form creator may use a variety of software applications, one example of which is Adobe® LiveCycle® Designer ES. In some other embodiments, some other software application is used. When creating an XML form, a form creator may perform some tasks or operations associated with the form which consume a substantial amount of time or processing resources. For example, opening a large form (e.g., with hundreds or thousands of pages) may require a process to go through and operate on or in general access each node in a hierarchy corresponding to a form. What is disclosed herein is a technique for processing a form (e.g., during development or creation of the form) using a multi-core processor and in particular assigning threads to operate on pages of the form and child nodes of those pages.

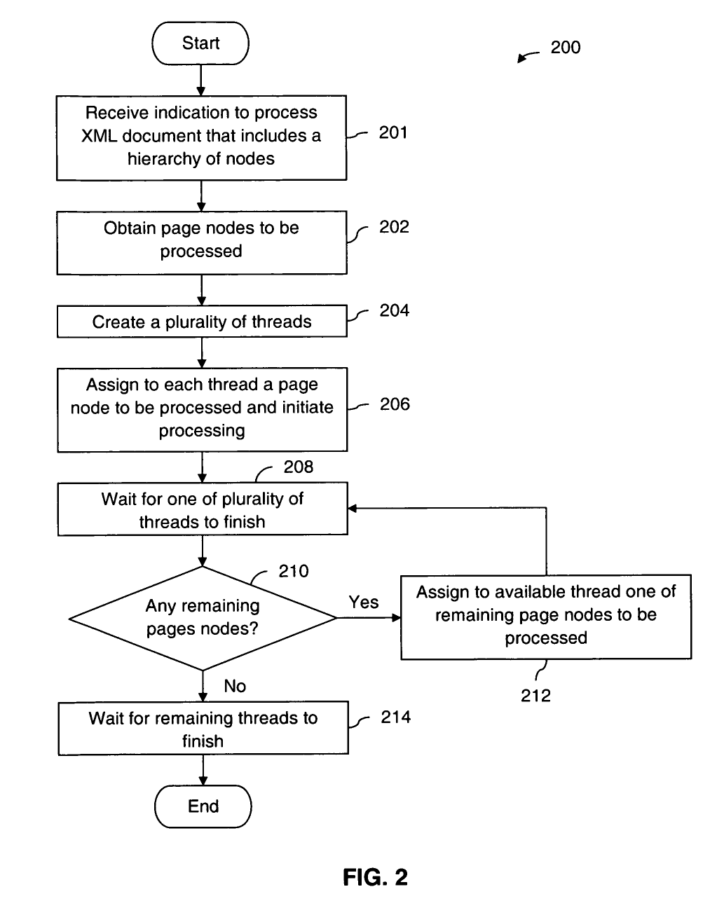

FIG. 2 is a flowchart illustrating an embodiment of a process for processing a form using a multi-core processor. In the example shown, multiple threads are created to operate on or otherwise process nodes of a form. In some embodiments, example process 200 is implemented in a form editing software application.

At 201, an indication to process an XML document that includes a hierarchy of nodes is received. At 202, page nodes to be processed are obtained. In some embodiments, obtaining page nodes to be processed includes determining the page nodes by accessing the hierarchy. In one example of accessing the hierarchy to determine page nodes, there is no knowledge or consistency regarding where page nodes are within a hierarchy. In some such embodiments, a process crawls or traverses through each node in a hierarchy to determine page nodes. In a second example of accessing the hierarchy to determine page nodes, the location of page nodes within a hierarchy is known and a process goes the known location to determine what page nodes there are. For example, in FIG. 1A it may be known (e.g., because of a stylistic convention) that all page nodes and only page nodes are in the second level of a hierarchy (i.e., children of root node 102), and a process in some embodiments goes to that location in the hierarchy and determines what nodes exist there and those nodes are determined to be the page nodes to be processed.

A plurality of threads is created at 204. In some embodiments, N threads are created if a software application is running on an N-core computer. In one example, a software application runs on an operating system which runs on a multi-core processor. By querying the operating system, the software application is able to obtain the number of cores and creates the same number of threads as cores.

At 206, a page is assigned to each thread to be processed and processing is initiated. A thread processes a given page node and all nodes below that particular page node. For example, a thread assigned to process node 106 associated with page 50 would also process nodes 114, 116, 118, 128, 130, 132, 134, and 136. The exact process(es) or task(s) performed by a thread upon a page node (and nodes below it) vary from embodiment to embodiment. In some cases, a form is being opened and tasks or processes associated with opening the form are performed on the nodes. In some cases, nodes in a form are being validated. In another example, a process identifies which nodes in the XML document are of a certain type.

Process 200 waits for one of the plurality of threads to finish at 208. A page node and all related nodes beneath it must be processed, as appropriate, before a thread is finished. At 210, it is determined whether there are any remaining page nodes. In some embodiments, a control process maintains a list of page nodes which remain to be processed and this list is updated each time a page node and related nodes beneath it are completed. If there is at least one remaining page node, one of the remaining page nodes is assigned to an available thread to be processed at 212. In this example, assigning a thread to begin processing a new page node occurs independently of the state of processing by other threads. For example, suppose there are four threads. Initially, each thread is assigned a page node (and related nodes beneath it) to process. If thread 3 is the first to finish, then that thread is assigned the next page node to be processed and it does not wait for the other threads to complete.

If there are no remaining page nodes at 210, process 200 waits for the remaining threads to finish at 214. Thread cleanup (as appropriate) is performed after processing is completed.

In some embodiments, one or more additional steps are performed (if needed) in addition to those shown in example process 200. In one example, additional steps to process nodes that do not descend from a page node or are not page nodes themselves are performed. Root node 102 in FIG. 1a is one such node—it is neither a page node nor does it descend from a page node. Another example is if root node 102 had non-page child node (in addition to nodes 104 and 106). In another example, steps are performed to clean up the plurality of threads as needed once processing has completed. In another example, a display of the result or output of the processing is rendered or otherwise displayed (e.g., to a user of a form editing software application) in an appropriate manner. For example, if the process is associated with opening a form (e.g., for editing or viewing by a form creator), form data may be displayed. For other processes, some other appropriate post-processing information is displayed.

In embodiments where a process crawls through a hierarchy to determine which nodes are page nodes at step 202, the process determines a node is associated with a page using a variety of techniques. In some embodiments, tags, comments or other metadata (e.g., associated with a node, object, or object attribute) are parsed for a particular value (e.g., the string “page”). In some embodiments, a process is instructed to identify those nodes that are of a certain type (e.g., a page node as opposed to a text node).

In some embodiments, a process saves a set or list of page nodes for future use. For example, after crawling through a hierarchy, a process may save the page nodes that were determined for future use so the process does not need to repeat this step (if possible). In some embodiments, a process is able to detect or determine when a saved list or set of page nodes is stale or otherwise out of date. In one example, a bit or register is set if (for example) a form creator adds a new node, deletes a node, or changes the type of object associated with a given node. If the bit is not set, then the process knows the saved information is up to date and can retrieve and use the stored information. In some embodiments, when recreating or updating a set of page nodes, only those nodes that have changed are accessed and/or only a portion of the set of page nodes is regenerated (i.e., at least some of the save information is still up to date and is useful). For example, when setting the bit or register described above, the location of the added, deleted or changed node can be stored and those specific portions of the hierarchy can be accessed. This eliminates the need to re-construct the entire set of page nodes and/or the need to crawl through the entire hierarchy.

One benefit to processing an XML document by page nodes and their descendants is that pages (e.g., as opposed to some other division of information) tend to be independent. One thread can process one page while another page is being processed by another page without (for example) having to wait for the other, which would reduce the efficiency of the system. Also, the likelihood that processing functions will need to read or update the same data across nodes that descend from different pages is lower than the likelihood for nodes from the same page. That is, it is oftentimes more efficient to process nodes that descend from the same page using the same thread. This can result in fewer critical sections.

Another benefit to processing an XML document by page nodes and their descendants is that a relatively good tradeoff between overhead and efficiency is achieved. For each thread that is created, there is some overhead associated with it (e.g., to create the thread, perform clean up after processing has completed, etc.). If data is divided up into relatively small groups of data, any processing gains would be overshadowed by the overhead. For example, if each thread processed a single node in an XML document, the amount of overhead would most likely outweigh any processing gains from multi-threading.

Although dependencies between page nodes and/or children of different page nodes exist, it should be noted that those dependencies exist at run time, not at design time (e.g., during creation of the form) to which the techniques disclosed herein are directed. For example, suppose an XML form is a credit card application and an applicant fills in his/her name and that value is propagated across the top of each page in the form. This interdependency occurs during run time, and does not necessarily exist during design time when the form is being created by a form creator.

One benefit to assigning the next page node (and its descendants) to the next available thread is that an XML document can be processed efficiently even if some pages and their descendants take much longer to process than other page nodes and their descendants. For example, one page may have many nodes that descend from it whereas another page node has much fewer descendant nodes, or one type of node may take much longer to process than another type of node. Another technique which pre-assigns all nodes to each thread prior to processing may have unbalanced loads.

In some cases, it may not be optimal to use the multi-thread technique disclosed herein. For example, if the overhead associated with creating multiple threads is greater than the overhead associated with creating a single thread. In some cases, the processing gains may not be worth the additional overhead. The following figure shows a process used in some embodiments to determine whether to use the multi-thread technique disclosed herein.

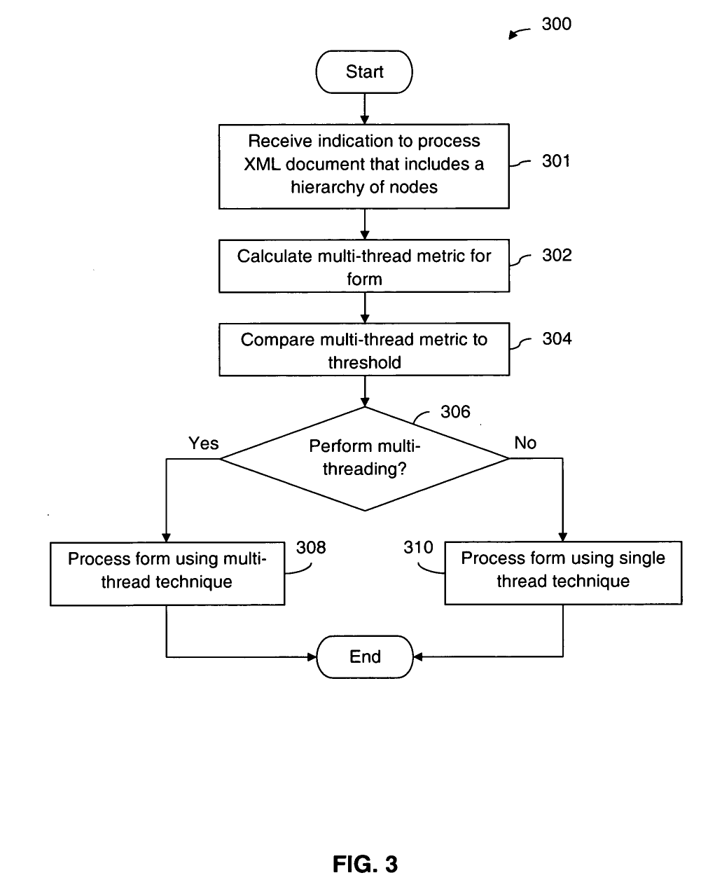

FIG. 3 is a flowchart illustrating an embodiment of a process for processing an XML form using a single thread or multiple threads. Process 300 begins at 301 when an indication to process an XML document that includes a hierarchy of nodes is received.

At 302, a multi-thread metric for the form is calculated. As used herein, a multi-thread metric is a measurement or reflection of the degree to which multi-threading (if used) would offer a performance improvement (or more generally, be beneficial) for a given form and/or the process which is to be performed on that form. For example, it is preferable to use multi-threading for a form with a relatively large number of nodes or pages in its hierarchy compared to a form with relatively few nodes. Correspondingly, the multi-thread metric for a large form versus a small form will reflect this. In some embodiments, the particular process which is to be performed on the form affects a multi-thread metric. For example, if the process affects all nodes in a hierarchy, using multi-threading to perform that process on the form would be more beneficial than using multi-threading to perform a process that only affected relatively few nodes in the hierarchy. In some embodiments, the number of objects that descend from one or more page nodes affects a multi-page metric (i.e., the depth of the hierarchy). In some embodiments, a number representative of the number of page nodes in a form (e.g., a mean or a median) is used in calculating a multi-page metric.

At 304, the multi-thread metric is compared to a threshold. It is determined at 306 whether to perform multi-threading. In one example, if the multi-thread metric is greater than the threshold, then it is determined to perform multi-threading. If so, a form is processed using a multi-thread technique at 308. For example, process 200 shown in FIG. 2 is used. Otherwise, a form is processed using a single thread technique at 310.

In some cases, a form editing software application was originally configured to operate in a single-core environment (i.e., using a single thread). In some other cases, a form editing software application is being developed and multi-core processors are available but at least some of the software developers do not have experience programming applications for a multi-core environment. The following embodiment shows one approach which can mitigate at least some of the issues in such scenarios.

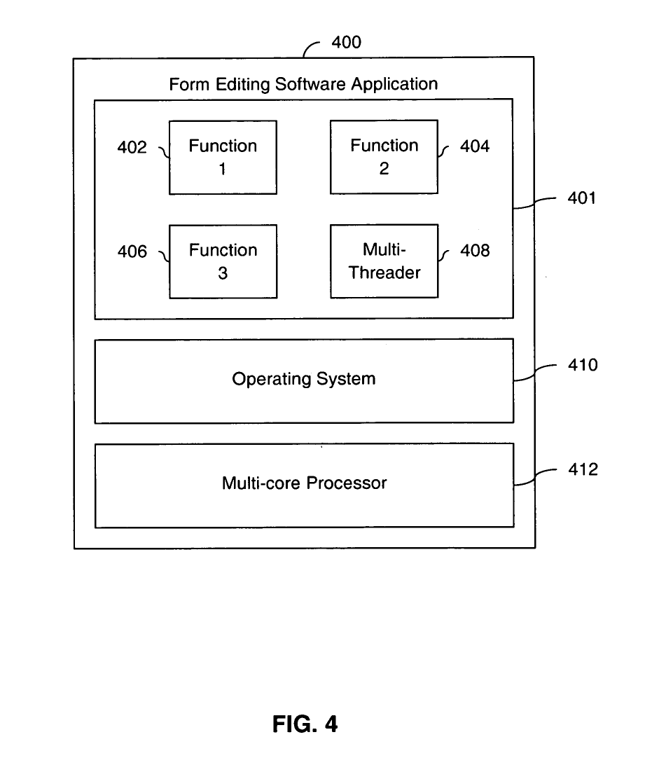

FIG. 4 is a system diagram showing an embodiment of a computer with a multi-core processor. In the example shown, computer 400 includes form editing software application 401 which interfaces with and is above operating system 410. Operating system 410 interfaces with and is located above multi-core processor 412.

Form editing software application 401 includes functions 1-3 (402, 404, and 406) and multi-threader 408. In this example, functions 1-3 are various functions for operating on an XML form, nodes in the XML form, or related data. In this particular example, multi-threader 408 is configured to handle multi-threading aspects of operation, for example by communicating with operating system 410 to obtain the number of processors available, create and manage a plurality of threads, etc. In some embodiments, multi-threader 408 performs thread management tasks, such as freeing memory and other resources when a thread ends.

In some embodiments, some or all of functions 1-3 (402, 404, and 408) are configured to support multi-thread operation, including by having appropriate critical sections defined. A critical section is used to identify a resource (such as a piece of code, memory, or other data) to prevent that critical section from being used or called at the same time by multiple entities (e.g., functions 1-3). For example, a critical section may be defined around a sub-routine to prevent two functions running on different threads from improperly calling it at the same time.

In some embodiments, components in form editing software application 401 are configured to avoid deadlocks. For example, function 1 (401) may be given page node to operate on and the run routine is called. The run routine in function 1 is a blocking function (i.e., it will wait for multi-threader 408 to finish). A deadlock scenario occurs when (for example) the main thread is waiting for one of plurality of threads to finish and vice versa. In some embodiments, a deadlock scenario is avoided by configuring a main thread to be able to receive messages from the plurality of threads (e.g., which is performing one of functions 1-3) at any time. This may include providing proper support for routing of a message to its destination (i.e., the main thread). Using such a solution, the main thread will receive the message it is waiting for and the system will not wait indefinitely.

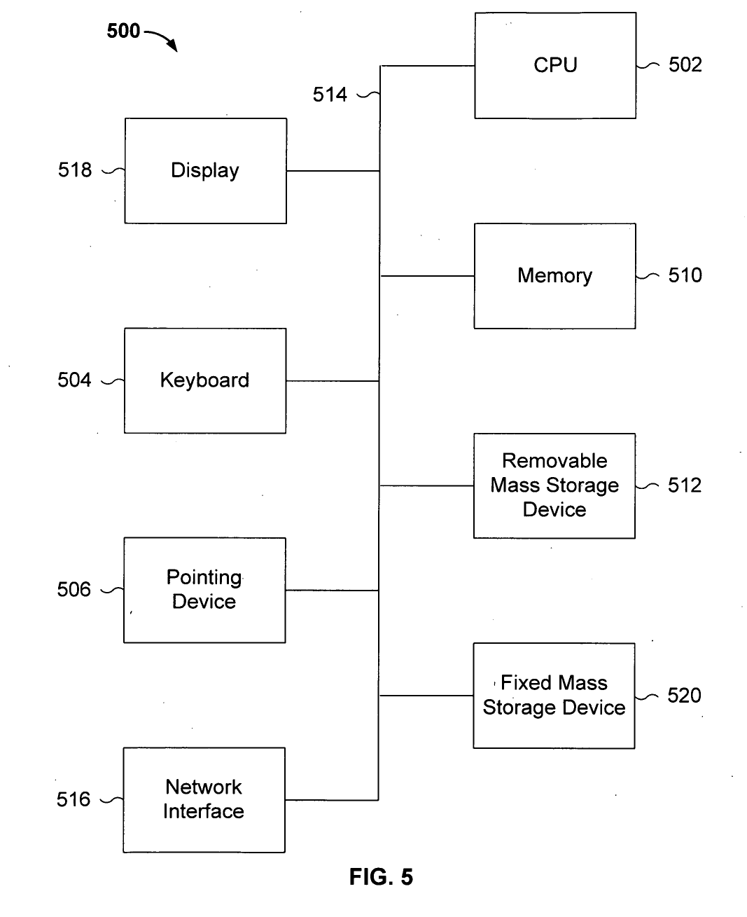

FIG. 5 is a block diagram of a computer system 500 used in some embodiments to perform variable type knowledge based call specialization. FIG. 5 illustrates one embodiment of a general purpose computer system. Other computer system architectures and configurations can be used for carrying out the processing of the techniques disclosed herein. Computer system 500, made up of various subsystems described below, includes at least one microprocessor subsystem (also referred to as a central processing unit, or CPU) 502. That is, CPU 502 can be implemented by a single-chip processor or by multiple processors. In some embodiments CPU 502 is a general purpose digital processor which controls the operation of the computer system 500. Using instructions retrieved from memory 510, the CPU 502 controls the reception and manipulation of input data, and the output and display of data on output devices. In some embodiments, CPU 502 comprises and/or is used to provide the parser & compiler 404, compiler & optimizer 406, and/or machine code generator 408 of FIG. 4 and/or implements the processes of FIGS. 3, 5, and/or 6.

CPU 502 is coupled bi-directionally with memory 510 which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on CPU 502. Also as well known in the art, primary storage typically includes basic operating instructions, program code, data and objects used by the CPU 502 to perform its functions. Primary storage devices 510 may include any suitable computer-readable storage media, described below, depending on whether, for example, data access needs to be bi-directional or uni-directional. CPU 502 can also directly and very rapidly retrieve and store frequently needed data in a cache memory (not shown).

A removable mass storage device 512 provides additional data storage capacity for the computer system 500, and is coupled either bi-directionally (read/write) or uni-directionally (read only) to CPU 502. Storage 512 may also include computer-readable media such as magnetic tape, flash memory, signals embodied on a carrier wave, PC-CARDS, portable mass storage devices, holographic storage devices, and other storage devices. A fixed mass storage 520 can also provide additional data storage capacity. The most common example of mass storage 520 is a hard disk drive. Mass storage 512, 520 generally store additional programming instructions, data, and the like that typically are not in active use by the CPU 502. It will be appreciated that the information retained within mass storage 512, 520 may be incorporated, if needed, in standard fashion as part of primary storage 510 (e.g. RAM) as virtual memory.

In addition to providing CPU 502 access to storage subsystems, bus 514 can be used to provide access other subsystems and devices as well. In the described embodiment, these can include a display monitor 518, a network interface 516, a keyboard 504, and a pointing device 506, as well as an auxiliary input/output device interface, a sound card, speakers, and other subsystems as needed. The pointing device 506 may be a mouse, stylus, track ball, or tablet, and is useful for interacting with a graphical user interface.

The network interface 516 allows CPU 502 to be coupled to another computer, computer network, or telecommunications network using a network connection as shown. Through the network interface 516, it is contemplated that the CPU 502 might receive information, e.g., data objects or program instructions, from another network, or might output information to another network in the course of performing the above-described method steps. Information, often represented as a sequence of instructions to be executed on a CPU, may be received from and outputted to another network, for example, in the form of a computer data signal embodied in a carrier wave. An interface card or similar device and appropriate software implemented by CPU 502 can be used to connect the computer system 500 to an external network and transfer data according to standard protocols. That is, method embodiments of the techniques may execute solely upon CPU 502, or may be performed across a network such as the Internet, intranet networks, or local area networks, in conjunction with a remote CPU that shares a portion of the processing. Additional mass storage devices (not shown) may also be connected to CPU 502 through network interface 516.

An auxiliary I/O device interface (not shown) can be used in conjunction with computer system 500. The auxiliary I/O device interface can include general and customized interfaces that allow the CPU 502 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments further related to computer storage products with a computer readable medium that contains program code for performing various computer-implemented operations. The computer-readable medium is any data storage device that can store data which can thereafter be read by a computer system. The media and program code may be those specially designed and constructed for the purposes of the present techniques, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter.

The computer system shown in FIG. 5 is but an example of a computer system suitable for use with the techniques. Other computer systems suitable for use with the techniques disclosed herein may include additional or fewer subsystems. In addition, bus 514 is illustrative of any interconnection scheme serving to link the subsystems. Other computer architectures having different configurations of subsystems may also be utilized.

In the foregoing detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the foregoing detailed description are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Although the foregoing embodiments have been described in some detail for purposes of clarity of understanding, the techniques are not limited to the details provided. There are many alternative ways of implementation. The disclosed embodiments are illustrative and not restrictive.

What is claimed is:

1. A method, comprising:
receiving, at a computer system, an indication to process an Extensible Markup Language (XML) document that includes a hierarchy of nodes;
obtaining a set of one or more page nodes to be processed, where the set of page nodes are part of the hierarchy of nodes, wherein each page node is a child of a root node, a subset of the page nodes includes child nodes, and each page node is associated with a page of the XML document;
identifying a number of processors for a multicore processor;
creating a number of threads equal to the number of processors;
assigning, to one of the plurality of threads to be processed by that thread, one of the page nodes and child nodes that descend from that page node; and
initiating processing, by said one of the plurality of threads, of the assigned page node and the child nodes that descend from that page node at one of the processors of the multicore processor.

2. The method recited in claim 1, wherein the set of page nodes are on a same level of the hierarchy.

3. The method recited in claim 1, wherein obtaining includes determining the set of page nodes by accessing at least some portion of the hierarchy.

4. The method recited in claim 3, wherein the determining further comprises crawling all nodes in the hierarchy.

5. The method recited in claim 3, wherein the determining further comprises accessing a predefined location within the hierarchy and determining those nodes at the predefined location.

6. The method recited in claim 3 further comprising saving the determined set of page nodes.

7. The method recited in claim 6 further comprising accessing the saved set of page nodes in the event a second indication to process the XML document is received.

8. The method recited in claim 7 further comprising determining whether the saved set of page nodes is up to date.

9. (canceled)

10. The method recited in claim 1 further comprising determining whether to process the XML document using the plurality of threads, wherein in the event it is determined to process the XML document using the plurality of threads, the computer instructions for creating, assigning, and initiating processing are executed.

11. The method recited in claim 10, wherein the determining comprises calculating a multi-thread metric and comparing the multithread metric to a threshold.

12. The method recited in claim 11, wherein the multi-thread metric is based on one or more of the number of page nodes in the set of page nodes and the process to be performed on the XML document.

13. The method recited in claim 1, wherein:
there is a second node in the hierarchy of nodes which does not descend from any of the set of page nodes; and
the method further comprises initiating processing, by one of the plurality of threads, of the second node.

14. (canceled)

15. (canceled)

16. A system, comprising:
a computer interface configured to:
receive an indication to process an Extensible Markup Language (XML) document that includes a hierarchy of nodes; and
obtain a set of one or more page nodes to be processed, where the set of page nodes are part of the hierarchy of nodes, wherein each page node is a child of a root node, a subset of the page nodes include child nodes, and each page node is associated with a page of the XML document; and
a computer processor configured to:
identify a number of processors for a multicore processor;
create a number of threads equal to the number of processors;
assign, to one of the plurality of threads to be processed by that thread, one of the page nodes and child nodes that descend from that page node; and
initiate processing, by said one of the plurality of threads, of the assigned page node and the child nodes that descend from that page node at one of the processors of the multicore processor.

17. The system recited in claim 16, wherein a multi-core processor executes the plurality of threads.

18. (canceled)

19. The system recited in claim 16, wherein the interface obtains by determining the set of page nodes by accessing at least some portion of the hierarchy.

20. The system recited in claim 19 further comprising a memory configured to save the determined set of page nodes.

21. The system recited in claim 20 further comprising a memory interface configured to access the saved set of page nodes in the event a second indication to process the XML document is received.

22. A computer program product, the computer program product being embodied in a non-transitory computer readable storage medium and comprising computer instructions for:
receiving an indication to process an Extensible Markup Language (XML) document that includes a hierarchy of nodes;
obtaining a set of one or more page nodes to be processed, where the set of page nodes are part of the hierarchy of nodes, wherein each page node is a child of a root node, a subset of the page nodes include child nodes, and each page node is associated with a page of the XML document;
identifying a number of processors for a multicore processor;
creating a number of threads equal to the number of processors;
assigning, to one of the plurality of threads to be processed by that thread, one of the page nodes and child nodes that descend from that page node; and
initiating processing, by said one of the plurality of threads, of the assigned page node and the child nodes that descend from that page node at one of the processors of the multicore processor.

23. A computer-implemented method comprising:
executing instructions on a specific apparatus so that binary digital electronic signals representing a set of one or more page nodes are obtained for processing, where the set of page nodes are part of a hierarchy of nodes in an Extensible Markup Language (XML) document, wherein each page node is a child of a root node, a subset of the page nodes includes child nodes, and each page node is associated with a page of the XML document;
executing instructions on a specific apparatus so that a number of processors for a multicore processor are identified;
executing instructions on a specific apparatus so that a number of threads equal to the number of processors are created;
executing instructions on a specific apparatus so that one of the page nodes and child nodes that descend from that page node are assigned to one of the plurality of threads, to be processed by that thread; and
executing instructions on a specific apparatus so that processing, by said one of the plurality of threads, of the assigned page node and the child nodes that descend from that page node is initiated at one of the processors of the multicore processor.

24. The method recited in claim 1, wherein the XML document is an XML form.
